(19) United States
(12) Patent Application Publication
(10) Pub. No.: US 2011/0270640 A1
(43) Pub. Date: Nov. 3, 2011

(54) System and method for actively managing client appointments

(76) Inventors: Warren Young, San Diego, CA (US); Hugh John Stewert Dawkins, Lathlain (AU); Steven Ross Vellacott, South Perth (AU)

(21) Appl. No.: 13/066,878

(22) Filed: Apr. 27, 2011

Related U.S. Application Data
(60) Provisional application No. 61/343,559, filed on Apr. 30, 2010.

(51) Int. Cl. G06Q 10/00

(52) U.S. Cl. 705/7.12

(57) ABSTRACT

The present invention provides client appointment scheduling systems and methods that monitors appointments and notifies clients if there is an advance or delay in the actual time the appointment will occur.

The present application claims benefit of priority to U.S. provisional patent application Ser. No. 61/343,559, filed on Apr. 30, 2010, which is incorporated herein by reference in its entirety.

### TECHNICAL FIELD

The present invention relates generally to the field of electronic appointment scheduling systems.

### BACKGROUND

Visits to a service provider's office or location, or a vendor's office or location, such as but not limited to health care provider's office or in particular physician's offices carry with them various risks for medical patients. One risk is potential exposure to viruses, bacterial and other hazards that can be transmitted from patient to patient in a waiting room environment. Moreover, the longer a patient is exposed to such conditions, the more likely it becomes that the patient will contract any number of these viruses and bacteria found in high-traffic waiting rooms. In addition to otherwise healthy patients, prolonged periods of time spent in waiting rooms creates a particularly increased risk to classes of high-risk patients such as the elderly or frail, newborn children, pregnant mothers, and immuno-compromised patients.

Further still, office visit waiting times are hard for doctors and office staff to estimate or avoid due to medical emergencies requiring a physician's immediate attention, extended consultations with other patients, and various other occurrences. Thus, office-visit wait time can become quite long. This often leads to overcrowded waiting rooms and frustrated patients. Patients can begin to resent that their time is being wasted unproductively sitting in a waiting room, which can in turn cause them to become dissatisfied with their physician and the medical staff. Moreover, clinic managers do not like the lack of control caused by delays in the daily schedule and often become over-stressed.

Besides increased exposure to viruses, bacteria and other illnesses, another disadvantage to overcrowded waiting rooms is that, because patients' appointment times are delayed, doctors often sustain increased business administration costs because they have to rent office space with a large enough waiting room to accommodate a large number of patients. Accordingly, increased overhead costs necessarily increases the overall cost of health care.

### SUMMARY

The present invention recognizes the need for efficient scheduling means, methods and systems to address the inefficiencies in scheduling appointments with vendors or service providers in a wide range of settings, such as but not limited to, those relating to patient or client appointments in the medical fields. The present invention provides a variety of aspects to address these needs and provides related benefits as well.

A first aspect of the present invention relates to a method for notifying clients of information pertaining to scheduled appointments including: a) entering at least one client information onto at least one tangible computer storage medium accessible to at least one client scheduling system computer; b) monitoring at least one scheduled appointment using said at least one client scheduling system computer; c) determining a time change in a first scheduled appointment at least in part based on at least one advance or delay in a second scheduled appointment, said second scheduled appointment being previous to said first scheduled appointment; and d) based at least in part on a time change, notifying a client associated with said first scheduled appointment by way of at least one personal electronic notification of an anticipated actual time of appointment.

A second aspect of the present invention relates to a method for notifying clients of expected wait times for appointments, including: a) entering at least one client information into at least one computer-based client scheduling system having at least one tangible processor and at least one tangible computer readable storage medium; b) determining advances or delays in later client appointments based on advances or delays in previous client appointments; and c) notifying patients via personal electronic notification of an anticipated actual time of appointment based on the advances or delays, thereby allowing clients to avoid spending prolonged, substantial, unwanted or unexpected periods of time in waiting rooms.

A third aspect of the present invention relates to a method in medical, para-medical and non-medical related settings, a method for notifying clients of expected wait times for professional appointments, including: a) entering at least one client information into at least one computer-based client scheduling system having at least one tangible processor and at least one tangible computer readable storage medium; b) determining advances or delays in later client appointments based on advances or delays in previous client appointments; and c) notifying clients via personal electronic notification of an anticipated actual time of appointment based on advances or delays in previous appointments, thereby allowing clients to avoid spending prolonged periods of time in waiting rooms or waiting for the professional to attend.

A fourth aspect of the present invention relates to a method for notifying patients of time information pertaining to scheduled medical appointments, including: a) entering at least one patient information into at least one tangible computer storage medium accessible to at least one patient scheduling system computer; b) monitoring scheduled appointments using the patient scheduling system computer; c) determining a time change in a first scheduled appointment at least in part based on at least one advance or delay in a second scheduled appointment, the second scheduled appointment being previous to the first scheduled appointment; d) based at least in part on the time change, notifying a patient associated with the first scheduled appointment via personal electronic notification of an anticipated actual time of a modified appointment to replace the first scheduled appointment; and e) receiving from the patient an electronic signal indicating that the patient accepts, rejects, cancels, desires to reschedule the modified appointment, or a combination thereof.

A fifth aspect of the present invention relates to a system, including: a) means for monitoring scheduled appointments; b) means for determining a time change in a first scheduled appointment at least in part based on at least one advance or delay in a second scheduled appointment, the second scheduled appointment being previous to the first scheduled appointment; c) means for notifying a patient associated with the first scheduled appointment via personal electronic notification of an anticipated actual time of a modified appointment to replace the first scheduled appointment based at least in part on the time change; and d) means for receiving from the patient an electronic message indicating that the patient accepts, rejects, cancels, or desires to reschedule the modified appointment.

### BRIEF DESCRIPTION OF THE FIGURES

FIG. 1 is a schematic diagram of a non-limiting implementation of the present system;

FIG. 2 is a flow chart of a non-limiting example of the system that can be implemented by the present system to generate a patient notification message.

FIG. 3 is a continuation of the flow chart displayed in FIG. 2.

FIG. 4 is another flow chart of a non-limiting example of the system that can be implemented by the present system to generate a patient notification message.

FIG. 5 is a continuation of the flow chart displayed in FIG. 4.

FIG. 6 is a flow chart of a non-limiting example of the system that can be implemented by the present system to send a patient notification message

FIG. 7 is a non-limiting exemplary schematic diagram of an implementation of the present system

FIG. 8 is another non-limiting exemplary schematic diagram of an implementation of the present system

FIG. 9 is another non-limiting exemplary schematic diagram of an implementation of the present system

FIG. 10 is another non-limiting exemplary schematic diagram of an implementation of the present system

### DETAILED DESCRIPTION OF THE INVENTION

The following description of the present invention focuses on one aspect of the present invention, which relates to patients, medical appointments, and a variety of medical service providers. However, the present invention is not limited to such an application and is applicable to any particular client, customer, type of appointment, type of scheduling, service provider, or vendor.

The details of the present invention, both as to its structure and operation, can best be understood in reference to the accompanying drawings, in which like reference numerals refer to like parts.

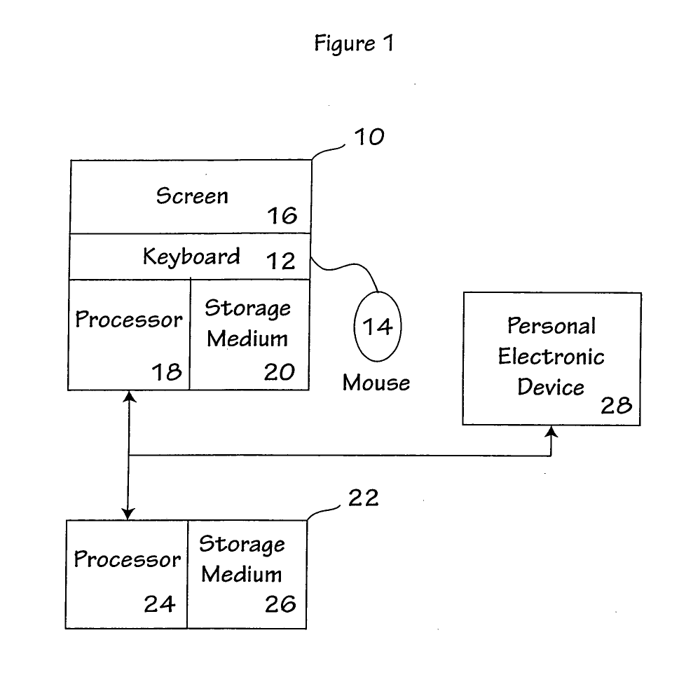

Beginning initially with FIG. 1, a schematic diagram of a non-limiting implementation of the present system for a patient notification process is shown. A user computer 10 is shown. The computer 10 is understood to be used by medical office and clinic personnel when scheduling medical appointments. The computer 10 can include one or more input devices such as a keyboard 12 and mouse device 14, as well as one or more output devices such as an electronic screen 16. It is to be understood that the keyboard 12 and mouse device 14 can be manipulated by a person scheduling a medical appointment while the screen 16 can provide a visual display of the person's actions. Further, the computer 10 also has a processor 18 and a tangible computer storage medium 20, the storage medium 20 understood to be capable of storing data including a software embodying system, which can further include all or part of the system discussed below.

As shown in FIG. 1, the user computer 10 can communicate with a server 22. The server 22 has a processor 24 and a storage medium 26, the storage medium 26 understood to be capable of storing data including software embodying system, which can further include all or part of the system discussed below. It is to be understood that the computer 10 can communicate with the server 22 through any means known within the art, including communication through wireless telecommunication technology, the internet, wireless, cable, satellite, or physical electronic cable linkage, either alone or in combination.

Thus, it can be appreciated that when medical office and clinic personnel enter scheduling information for a medical appointment, that information can be stored either on the user computer 10 or the server 22 in non-limiting embodiments, or both in still other non-limiting embodiments. Moreover, it is to be understood that the user computer 10 can be capable of accessing scheduling information regardless of whether it is stored on the computer 10 or server 22.

Still in reference to FIG. 1, a patient personal electronic device 28 is shown. The personal electronic device 28 can be a mobile telephone or a personal computer in non-limiting embodiments. However, the personal electronic device 28 can be any device capable of electronically communicating with other electronic devices. It is to be understood that such communication can occur in any number of ways known within the art, including wireless telecommunication technology, the internet and physical electronic cable linkage in non-limiting embodiments.

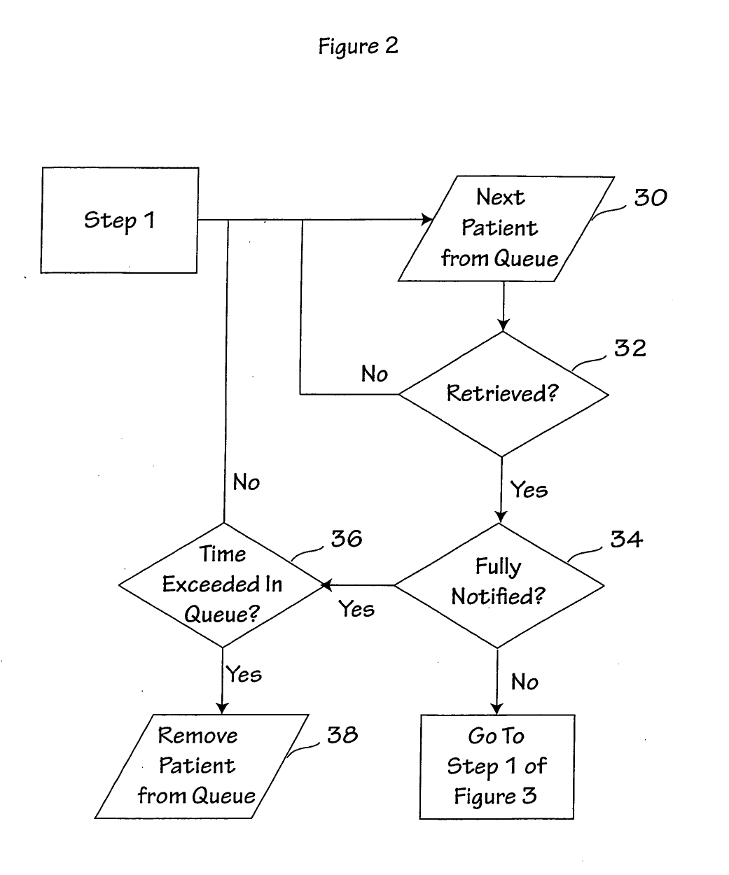

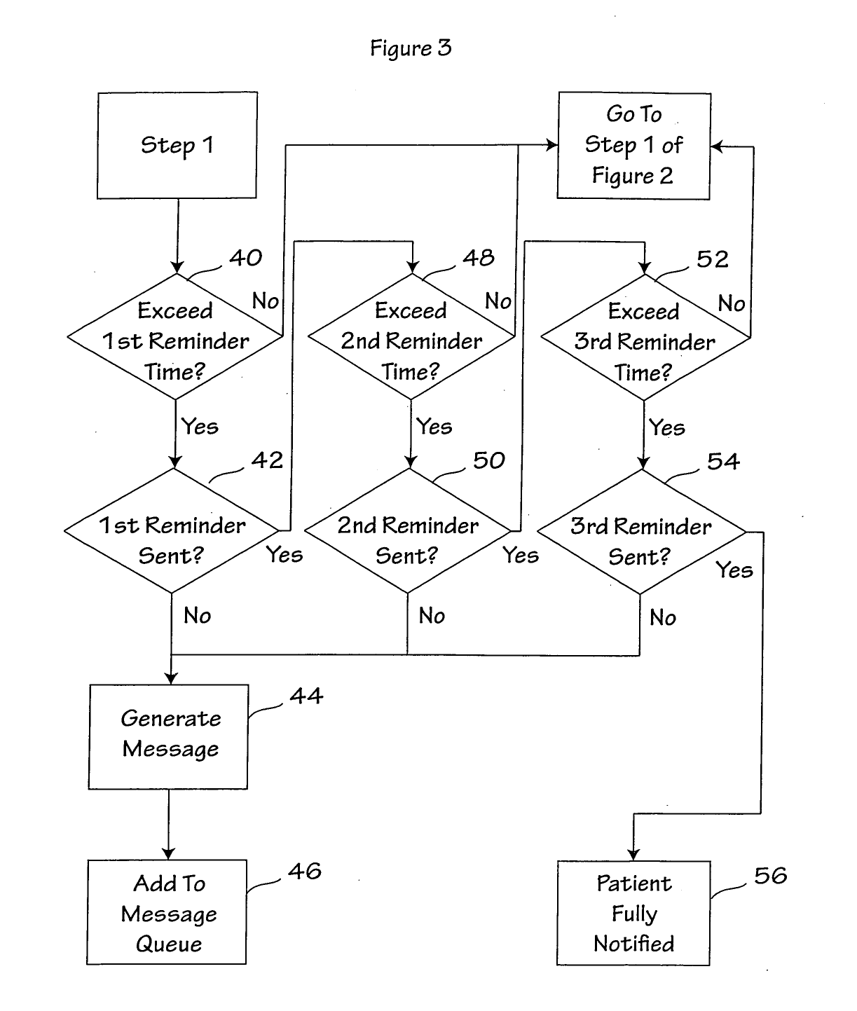

With the above structure in mind, operation of the system can now be understood in reference to the non-limiting flow-chart shown in FIG. 2 and its continuation shown in FIG. 3, where a first example of the system that can be implemented by the present system to monitor scheduled patient appointments is shown. Beginning at block 30, the system retrieves patient information from a patient queue for a patient having a scheduled appointment. The patient queue is understood to consist of patients with scheduled appointments, the patient queue being created by the Private Waiting Room (PWR) in accordance with present principles. It is to be further understood that the PWR patient queue can be created using scheduling information retrieved from any non-limiting patient scheduling system a physician's office can use to schedule patient appointments.

Still in reference to FIG. 2 and FIG. 3, the system determines whether patient information for a patient having a scheduled appointment has been retrieved from the patient queue at decision diamond 32. If no information was retrieved because, for example, there are no patients in the patient queue, then the system reverts back to block 30 and the system can be repeated. However, if at diamond 32 the system determines that patient information has been retrieved from the patient queue, the system then moves to diamond 34 where it is determined whether the patient whose information was retrieved has been fully notified.

If at diamond 34 the system determines that the patient has been fully notified, the system then moves to decision diamond 36. It is to be understood that, in non-limiting embodiments such as the one shown in FIG. 2 and FIG. 3, a patient queue removal time can be predetermined. Once a patient queue removal time has been predetermined, the system can subsequently use the predetermined time to retain patient information in the patient queue even after a patient's appointment time has passed or the patient has met with a physician or medical professional. Thus, at diamond 36, the system determines whether a predetermined patient queue removal time has been exceeded. If the system determines that it has not, the system reverts back to block 30 and the process can be repeated. But if the system determines that the predetermined patient queue removal time has been exceeded, the system moves to block 38 where the patient information is removed from the patient queue and can be placed in an archive list. Thereafter, the system can either conclude or revert back to block 30 to repeat the process for other patients.

Reverting back to diamond 34, if the system determines that a patient has not been fully notified, the system instead moves to decision diamond 40. At diamond 40, the system determines whether a predetermined first reminder time has been reached. If the appropriate first reminder time has not been reached, the system reverts back to block 30 and the process can repeat. If, however, the appropriate time to send a first reminder has been reached, the system moves to decision diamond 42 where the system determines whether a first reminder message has been sent.

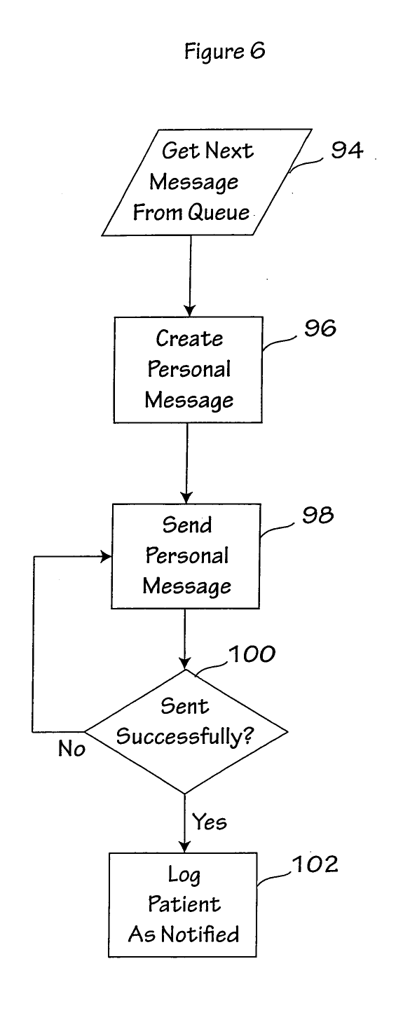

If the system determines at diamond 42 that the first reminder message has not been sent, the system moves to block 44 where a reminder message is generated. It is to be understood that the reminder message can contain temporal information relating to when a patient's appointment with a physician is to occur. The system then moves to block 46, where the reminder message is added to a message queue which can hold reminder messages generated by the PWR. After the reminder message has been added to the message queue at block 46, the system can then move to FIG. 6 for the system for the message sending process, which will be discussed later.

However, reverting back to diamond 42, if the system determines that a first reminder message has been sent, the system instead moves to diamond 48. At diamond 48, the system determines whether a predetermined second reminder time has been reached. If the second reminder time has not been reached, the system reverts back to block 30 and the process can repeat. If, however, the appropriate time to send a second reminder has been reached, the system moves to diamond 50.

At diamond 50, the system determines whether a second reminder message has been sent. If the system determines at diamond 50 that the second reminder message has not been sent, the system moves to block 44 where a reminder message is generated. It is to be understood that the reminder message can contain temporal information relating to when a patient's appointment with a physician is to occur. The system then moves to block 46, where the reminder message is added to a message queue which can hold reminder messages generated by the PWR. After the reminder message has been added to the message queue at block 46, the system can then move to FIG. 6, which provides a non-limiting example of the message sending process.

Still in reference to FIG. 2 and FIG. 3, if the system determines at diamond 50 that a second reminder message has been sent, the system instead moves to diamond 52. At diamond 52, the system determines whether a predetermined third reminder time has been reached. If the third reminder time has not been reached, the system reverts back to block 30 and the process can repeat. If, however, the appropriate time to send a third reminder has been reached, the system moves to diamond 54.

At diamond 54, the system determines whether a third reminder message has been sent. If the system determines at diamond 54 that the third reminder message has not been sent, the system moves to block 44 where a reminder message is generated. It is to be understood that the reminder message can contain temporal information relating to when a patient's appointment with a physician is to occur. The system then moves to block 46, where the reminder message is added to a message queue which can hold reminder messages generated by the PWR. After the reminder message has been added to the message queue at block 46, the system can then move to FIG. 6 for the system for the message sending process, which will be discussed later.

Alternatively, if the system determines at diamond 54 that a third reminder message has already been sent, the system instead moves to block 56. At block 56, the patient is determined to be fully notified and can be removed from the patient queue.

It is to be understood that while sending three reminder messages is described in FIG. 2 and FIG. 3, any number of reminder messages can be sent. Particularly sending three reminder messages has been disclosed for illustration only. The language of FIG. 2 and FIG. 3 should not be construed to limit the present embodiment to a definite number of messages.

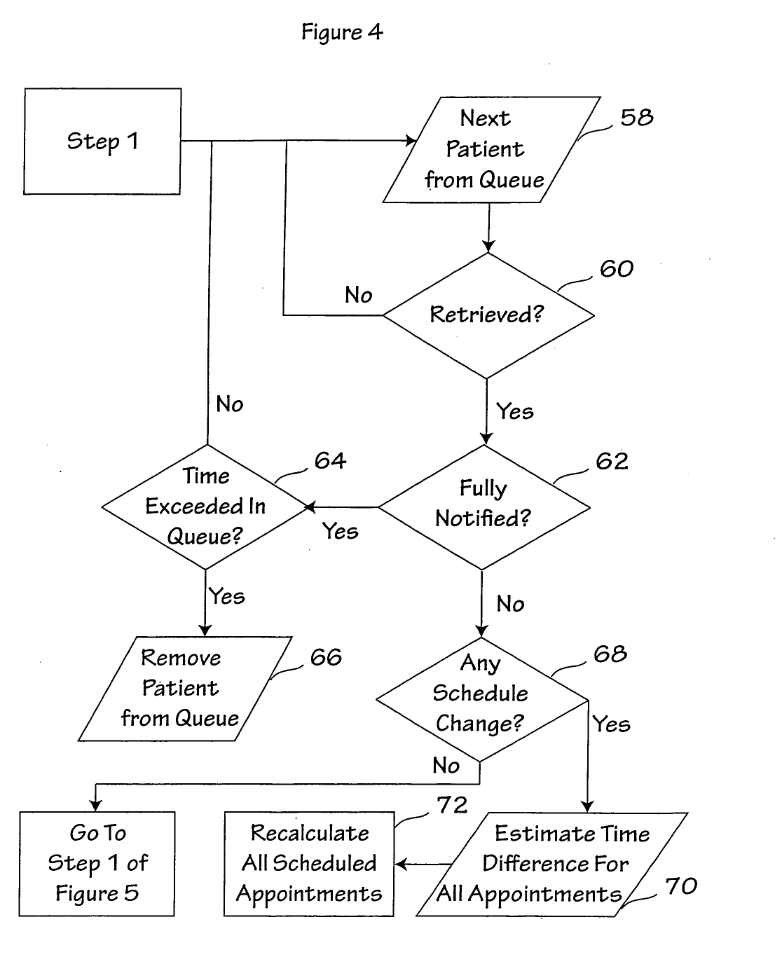

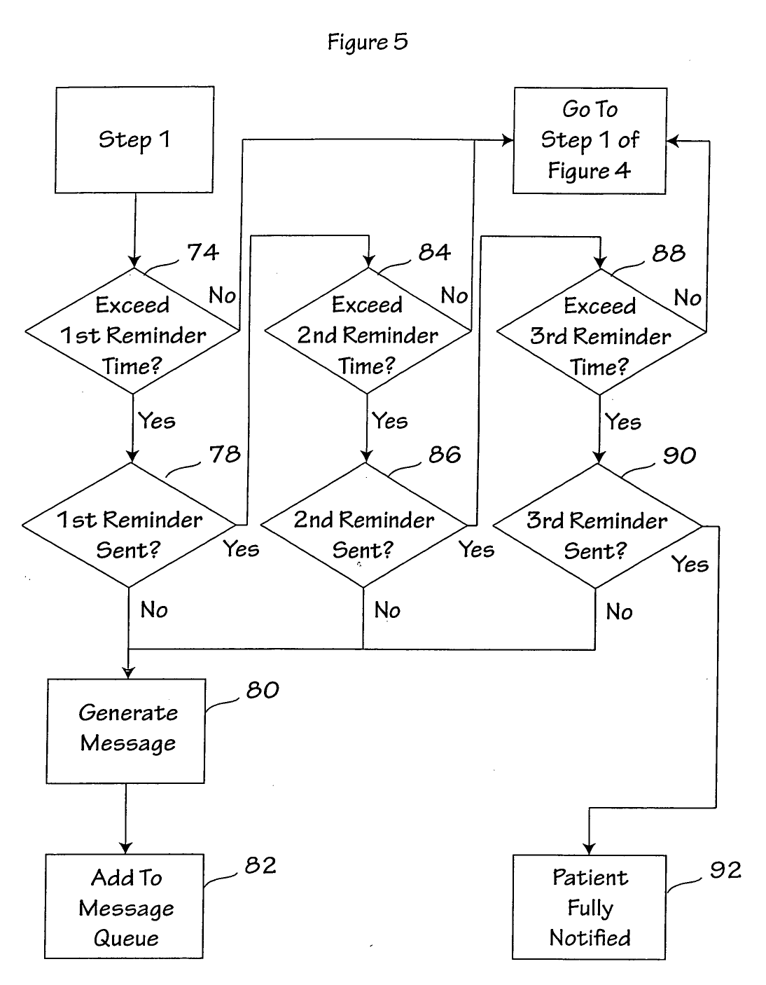

Now in reference to FIG. 4 and FIG. 5, a second example of the system that can be implemented by the present system is shown. Beginning at block 58, the system retrieves patient information for a patient having a scheduled appointment from a patient queue. The patient queue is understood to consist of a list of patients with scheduled appointments, the patient queue being created by the PWR. It is to be further understood that PWR patient queue can be created using scheduling information retrieved from any non-limiting patient scheduling system a physician's office can use to schedule patient appointments.

Still in reference to FIG. 4 and FIG. 5, the system determines whether patient information for a patient having a scheduled appointment has been retrieved from the patient queue at decision diamond 60. If no information was retrieved because, for example, there are no patients in the patient queue, then the system reverts back to block 58 and the system can be repeated. However, if at diamond 60 the system determines that patient information has been retrieved from the patient queue, the system then moves to diamond 62 where it is determined whether the patient whose information was retrieved has been fully notified.

If at diamond 62 the system determines that the patient has been fully notified, the system then moves to decision diamond 64. It is to be understood that, in non-limiting embodiments, a patient queue removal time can be predetermined. Once a patient queue removal time has been predetermined, the system can subsequently use this time to keep patient information in the patient queue even after a patient's appointment time has passed or the patient has met with a physician or medical professional. Thus, at diamond 64, the system determines whether a predetermined patient queue removal time has been exceeded. If the system determines that is has not, the system reverts back to block 58 and the process can be repeated. But if the system determines that the predetermined patient queue removal time has been exceeded, the system moves to block 66 where the patient information is removed from the patient queue and can be placed in an archive list. Thereafter, the system can either conclude or revert back to block 58 to repeat the process for other patients.

Reverting back to diamond 62, if the system determines that a patient has not been fully notified, the system then moves to decision diamond 68. At diamond 68, the system determines whether there has been a schedule change in a previous appointment affecting later scheduled appointments, i.e. an advance or delay in a second appointment occurring temporally previous to a first appointment that will affect whether the first appointment will commence at the scheduled time. If at diamond 68 the system determines that there has been a change affecting the schedule of appointments, the system then moves to block 70. At block 70, the system estimates the length of an advance or delay in all scheduled appointments. Then the system moves to block 72 where all affected patient reminders are recalculated for the remaining patients on the schedule. The system can then revert back to block 58.

However, if at diamond 68 the system determines that there has not been a change affecting the schedule of appointments, the system instead moves to decision diamond 74. At diamond 74, the system determines whether a predetermined first reminder time has been reached. If the appropriate first reminder time has not been reached, the system reverts back to block 58 and the process can repeat. If, however, the appropriate time to send a first reminder has been reached, the system moves to decision diamond 78 where the system determines whether a first reminder message has been sent.

If the system determines at diamond 78 that the first reminder message has not been sent, the system moves to block 80 where a reminder message is generated. It is to be understood that the reminder message can contain temporal information relating to when a patient's appointment with a physician is to occur. The system thereafter moves to block 82, where the reminder message is added to a message queue which can hold reminder messages generated by the PWR. After the reminder message has been added to the message queue at block 82, the system can then move to FIG. 6, which provides a non-limiting example of the message sending process.

However, reverting back to diamond 78, if the system determines that a first reminder message has been sent, the system instead moves to diamond 84. At diamond 84, the system determines whether a predetermined second reminder time has been reached. If the second reminder time has not been reached, the system reverts back to block 58 and the process can repeat. If, however, the appropriate time to send a second reminder has been reached, the system moves to diamond 86.

At diamond 86, the system determines whether a second reminder message has been sent. If the system determines at diamond 86 that the second reminder message has not been sent, the system moves to block 80 where a reminder message is generated. It is to be understood that the reminder message can contain temporal information relating to when a patient's appointment with a physician is to occur. The system then moves to block 82, where the reminder message is added to a message queue which can hold reminder messages generated by the PWR. After the reminder message has been added to the message queue at block 82, the system can then move to FIG. 6 for the system for the message sending process, which will be discussed later.

Still in reference to FIG. 4 and FIG. 5, if the system determines at diamond 86 that a second reminder message has been sent, the system instead moves to diamond 88. At diamond 88, the system determines whether a predetermined third reminder time has been reached. If the third reminder time has not been reached, the system reverts back to block 58 and the process can repeat. If, however, the appropriate time to send a third reminder has been reached, the system moves to diamond 90.

At diamond 90, the system determines whether a third reminder message has been sent. If the system determines at diamond 90 that the third reminder message has not been sent, the system moves to block 80 where a reminder message is generated. It is to be understood that the reminder message can contain temporal information relating to when a patient's appointment with a physician is to occur. The system then moves to block 82, where the reminder message is added to a message queue which can hold reminder messages generated by the PWR. After the reminder message has been added to the message queue at block 82, the system can then move to FIG. 6 for the system for the message sending process, which will be discussed below.

Alternatively, if the system determines at diamond 90 that a third reminder message has already been sent, the system instead moves to block 92. At block 92, the patient is determined to be fully notified and can be removed from the queue.

It is to be understood that while sending three reminder messages are described in FIG. 4 and FIG. 5, any number of reminder messages can be sent. Particularly sending three reminder messages has been disclosed for illustration only. The language of FIG. 4 and FIG. 5 should not be construed to limit the present embodiment to a definite number of messages.

Moving to FIG. 6, the system process for sending a message from the message queue once it has been received as described in FIG. 2 and FIG. 3 and as described in FIG. 4 and FIG. 5 is shown. Beginning at block 94, a message is received into the message queue. The system then moves to block 96 where a personal electronic notification message is created from the reminder message received by the queue at block 94. This personal electronic notification message can be generated using any acceptable electronic communication format as is known in the art and described herein. One such format is the Short Message Service (SMS) format, but it is to be understood that the SMS format is only a suggested, non-limiting format and that other formats appropriate within the art can also be used, such as, but not limited to mobile phone software applications, including but not limited to the Apple iOS™ applications and the Android™ applications.

Still in reference to FIG. 6, the system then moves from block 96 to block 98 where a personal electronic notification message is sent to the patient who is to receive notification information on a scheduled appointment. This message can be sent to the patient through any non-limiting electronic means which include, but are not limited to, sending a message to a cellular telephone or email address. After sending the message, the system then moves to decision diamond 100 where the system determines if the message was successfully sent to the patient. If at diamond 100 the system determines that the message was not successfully sent, the system reverts to block 98 and the message is sent again. If, however, at diamond 100 the system determines the message was successfully sent, the system then moves to block 102, where the system enters the status of the notification, i.e. that a reminder message has been sent, into the PWR (Private Waiting Room) system.

Though not shown in FIG. 6, it is to be understood that once the message is sent at block 98 and successfully received by the patient as determined at diamond 100, in non-limiting embodiments the patient can electronically respond to the PWR message. Particularly, this response can pertain to the patient being notified of a change to the scheduled appointment time. Thus, a patient's response can include information on whether the patient accepts, rejects or wishes to reschedule the medical appointment which the patient notification message has indicated would be temporally altered.

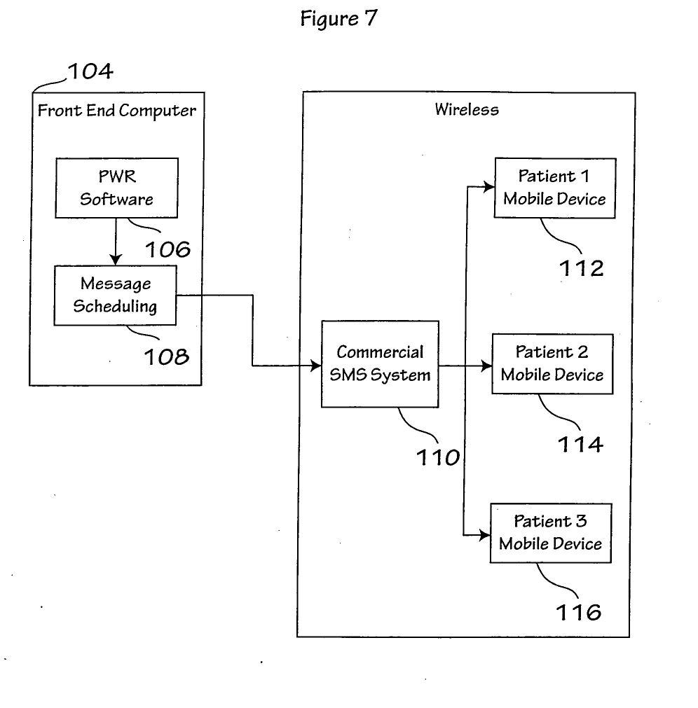

Now in reference to FIG. 7, a non-limiting exemplary schematic diagram of an implementation of the present system is shown. A front-end computer 104 (e.g. user computer such as a medical office computer used by medical personnel) is shown. The computer 104 has PWR software 106. In the implementation shown in FIG. 7, patient scheduling information can be manually entered into the PWR software 106 by medical office personnel. The PWR software 106 can then generate a patient notification message to be sent to a patient.

Still in reference to FIG. 7, the PWR software 106 can send the patient notification message to a message scheduling system 108. The message scheduling system 108 is understood to be capable of electronically communicating with a commercial SMS system 110 to send an electronic message to a user using any appropriate messaging system known in the art and as described herein. Thus, a message that is designated for sending to a patient at a designated time by the scheduling system 108 is then sent to the SMS system 110. Once a message is received by the SMS system 110, the SMS system 110 can then send the generated message to one or more patient electronic devices. Patient mobile device 112, mobile device 114 and mobile device 116 are electronic devices which can receive a message. The plural mobile devices 112, 114 and 116 can receive different scheduling messages or they can all receive the same scheduling message in non-limiting embodiments.

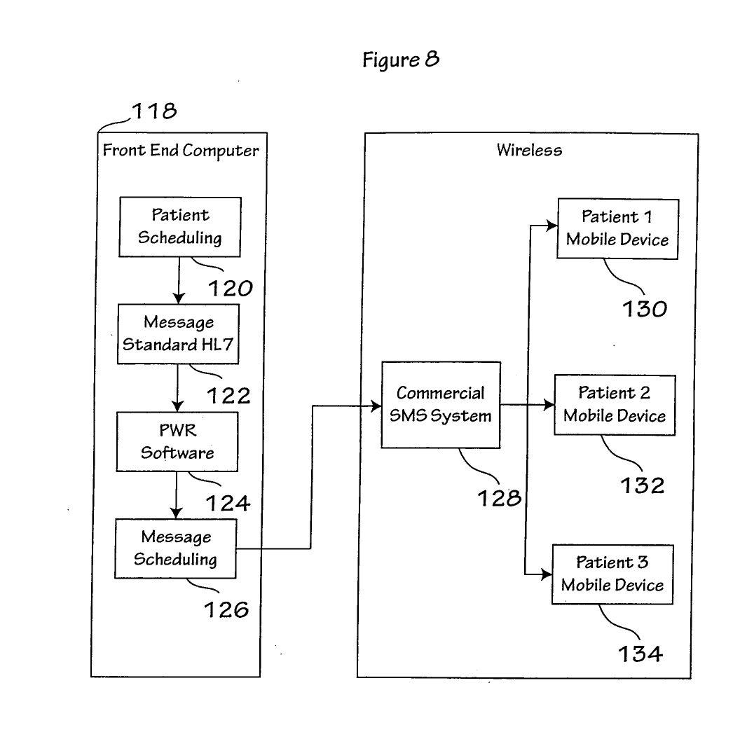

Now in reference to FIG. 8, another non-limiting exemplary schematic diagram of an implementation of the present system is shown. A front end computer 118, e.g. user client scheduling system computer which can be used by medical personnel, is shown. The computer 118 has a patient scheduling system 120. The scheduling system 120 is understood to be any non-limiting patient scheduling system a physician's office can use to schedule patient appointments. Thus, a person such as a medical office assistant can enter patient information into the scheduling system 120 through the computer 118.

Once the patient information has been received by the scheduling system 120, the information can be sent through an HL7 (Health Level 7) messaging standard 122 to be received by the PWR software 124. HL7 messaging is a standard known within the art which includes a means for patient information to be exchanged between medical software applications. However, it is to be understood that there are multiple alternative appropriate ways to automatically exchange patient information that can be used in accordance with present principles, such as storing patient information in an electronic folder that can be shared by multiple software applications. However, HL7 messaging is used in the current, non-limiting example shown in FIG. 8.

Thus, the HL7 messaging standard 122 facilitates the exchange of patient information between the patient scheduling system 120 and the PWR software 124. Once patient information has been received by the Private Waiting Room software 124 via the HL7 messaging standard 122, the Private Waiting Room software 124 can generate an electronic patient notification message, which the Private Waiting Room software can then send to a message scheduling system 126. The message scheduling system 126 is understood to be capable of electronically communicating with a commercial SMS system 128 to send an electronic message to a user. Thus, a message that is designated for sending to a patient at a designated time by the scheduling system 126 is then sent to the SMS system 128. Once a message is received by the SMS system 128, the SMS system 128 can then send the generated message to one or more patient electronic devices. Patient mobile device 130, mobile device 132 and mobile device 134 are three electronic devices which can receive a message. The plural mobile devices 130, 132 and 134 can receive different scheduling messages or they can all receive the same scheduling message in non-limiting embodiments.

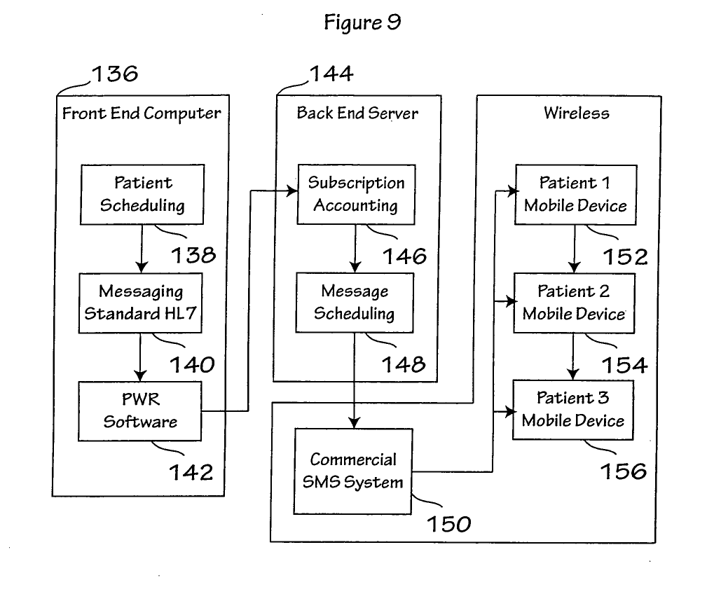

Moving now to FIG. 9, yet another non-limiting exemplary schematic diagram of an implementation of the present system is shown. A front end computer 136, e.g. user client scheduling system computer which can be used by medical personnel, is shown. The computer 136 has a patient scheduling system 138. The scheduling system 138 is understood to be any non-limiting patient scheduling system a physician's office can use to schedule patient appointments. Thus, a person such as a medical office assistant can enter patient information into the scheduling system 138 through the computer 136.

Once the patient information has been received by the scheduling system 138, the information can be sent through an HL7 (Health Level 7) messaging standard 140 to be received by the PWR software 142. The HL7 messaging standard 140 is understood to be substantially similar in function and configuration to the HL7 messaging standard 122 in FIG. 8. However, it is to be further understood that there are multiple alternative appropriate ways to automatically exchange patient information that can be used in accordance with present principles, as described in reference to FIG. 8. However, HL7 messaging is used in the current, non-limiting example shown in FIG. 9.

Thus, the HL7 messaging standard 140 facilitates the exchange of patient information between the patient scheduling system 138 and the PWR software 142. Once patient information has been received by the PWR software 142 via the HL7 messaging standard 140, the PWR software 142 can then generate a patient notification message and send it to a subscription accounting system 146 on a back-end server 144. The communication between the PWR software 142 on the computer 136 and the subscription accounting system 146 on the server 144 can be done through any electronic communication means known within the art.

Once patient information has been received by the subscription accounting system 146, the accounting system 146 can then electronically record that medical office personnel are notifying a patient of scheduling-related information. Thus, it is the role of the accounting system 146 to track messages sent from medical offices so that those offices can compensate the proprietors of the PWR software for sent messages.

After the subscription accounting system 146 has recorded the appropriate information, the patient message that was generated by the PWR software 142 can then be sent to a message scheduling system 148, which designates the patient notification message for sending at the appropriate time. It is to be understood that the message scheduling system 148 is capable of electronically communicating with a commercial SMS system 150 to send an electronic message to a user.

Accordingly, the message can be sent to the SMS system 150 by the message scheduling system 148 so that the patient notification message can be sent to a patient by the SMS system 150 at a designated time. Thus, once a message is indeed received by the SMS system 150, the SMS system 150 can then send the generated message to one or more patient electronic devices. Patient mobile device 152, mobile device 154 and mobile device 156 are electronic devices which can receive a message. The plural mobile devices 152, 154 and 156 can receive different scheduling messages or they can all receive the same scheduling message in non-limiting embodiments.

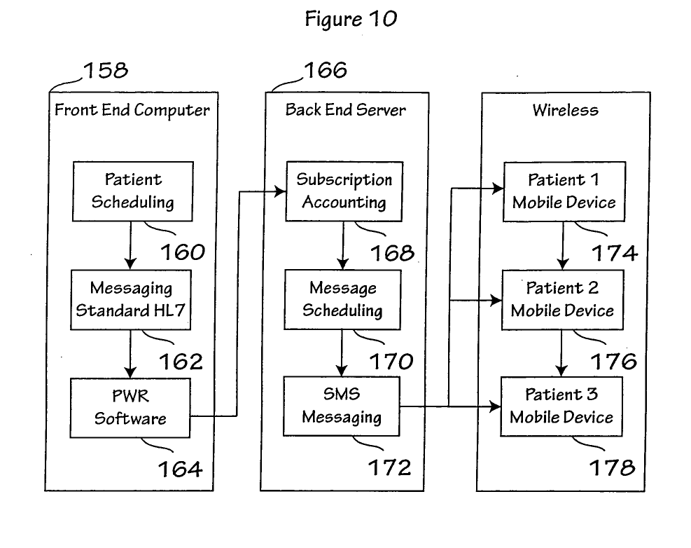

Concluding with FIG. 10, one more non-limiting exemplary schematic diagram of an implementation of the present system is shown. A front end computer 158 (e.g. user client scheduling system computer which can be used by medical personnel) is shown. The computer 158 has a patient scheduling system 160. The scheduling system 160 is understood to be any non-limiting patient scheduling system a physician's office can use to schedule patient appointments. Thus, a person such as a medical office assistant can enter patient information into the scheduling system 160 through the computer 158.

Once the patient information has been received by the scheduling system 160, the information can be sent through an HL7 (Health Level 7) messaging standard 162 to be received by the PWR software 164. The HL7 messaging standard 162 is understood to be substantially similar in function and configuration to the HL7 messaging standard 122 in FIG. 8. However, it is to be further understood that there are multiple alternative appropriate ways to automatically exchange patient information that can be used in accordance with present principles, as described in reference to FIG. 8. However, HL7 messaging is used in the current, non-limiting example shown in FIG. 10.

Thus, the HL7 messaging standard 162 facilitates the exchange of patient information between the patient scheduling system 160 and the PWR software 164. Once patient information has been received by the PWR software 164 via the HL7 messaging standard 162, the PWR software 164 can then generate a patient notification message and send it to a subscription accounting system 168 on a back-end server 166. The communication between the PWR software 164 on the computer 158 and the subscription accounting system 168 on the server 166 can be done through any electronic communication means known within the art.

Once patient information has been received by the subscription accounting system 168, the accounting system 168 can then electronically record that medical office personnel are notifying a patient of scheduling-related information. Thus, it is the role of the accounting system 168 to track messages sent from medical offices so that those offices can compensate the proprietors of the PWR software for sent messages.

After the subscription accounting system 168 has recorded the appropriate information, the patient message that was generated by the Private Waiting Room software 164 can then be sent to a message scheduling system 170, which designates the patient notification message for sending at the appropriate time. Differing from FIG. 9, it is to be understood that in FIG. 10, the message scheduling system 170 is capable of electronically communicating with an SMS system 172 located on the server 166 to send an electronic message rather than using a commercial SMS system to send an electronic message as shown in FIG. 7, FIG. 8 and FIG. 9.

Accordingly, the message can be sent to the SMS system 172 by the message scheduling system 170 so that the patient notification message can be sent to a patient by the SMS system 172 at a designated time. Thus, once a message is received by the SMS system 172, the SMS system 172 can then send the generated message to one or more patient electronic devices. Patient mobile device 174, mobile device 176 and mobile device 178 are electronic devices which can receive a message. The plural mobile devices 174, 176 and 178 can receive different scheduling messages or they can all receive the same scheduling message in non-limiting embodiments.

In reference to FIG. 1 through FIG. 10, it is to be understood that while the patient notification process described above was described in the context of medical appointments, it is to be understood that the present invention can be used in many other appointment contexts not disclosed herein. For example, it could be used for legal appointments, automotive appointments, employment appointments, etc.

All publications, including patent documents and scientific or other articles, referred to in this application are incorporated by reference in their entirety for all purposes to the same extent as if each individual publication were individually incorporated by reference.

All headings are for the convenience of the reader and should not be used to limit the meaning of the text that follows the heading, unless so specified.

Absent express definitions herein and claim terms are to be given all ordinary and accustomed meanings. When the singular is referred to, the plural is intended to be included. Likewise, when the plural is referred to, the singular is intended to be included.

What is claimed is:

1. A method for notifying clients of information pertaining to scheduled appointments, comprising:
a) entering at least one client information onto at least one tangible computer storage medium accessible to at least one client scheduling system computer;
b) monitoring at least one scheduled appointment using said at least one client scheduling system computer;
c) determining a time change in a first scheduled appointment at least in part based on at least one advance or delay in a second scheduled appointment, said second scheduled appointment being previous to said first scheduled appointment; and
d) based at least in part on a time change, notifying a client associated with said first scheduled appointment by way of at least one personal electronic notification of an anticipated actual time of appointment.

2. The method of claim 1, wherein said notified client is a client seeking consultation or advice.

3. The method of claim 1, wherein information pertaining to scheduled appointments includes temporal information related to the anticipated actual time of appointment.

4. The method of claim 1, wherein said at least one client information entered into said at least one a tangible computer storage medium is entered from at least one telecommunication device such as a personal computer.

5. The method of claim 1, wherein said at least one client information includes client name.

6. The method of claim 1, wherein said at least one client information includes scheduled time of appointment.

7. The method of claim 1, wherein said at least one client information includes at least one of the client's mobile telephone number, email address, other personal electronic notification format, or a combination thereof.

8. The method of claim 1, wherein said at least one personal electronic notification is email.

9. The method of claim 1, wherein said at least on personal electronic notification is telephone text messaging.

10. The method of claim 1, wherein said at least one personal electronic notification is an automated voice message.

11. A method for notifying clients of expected wait times for appointments, comprising:
a) entering at least one client information into at least one computer-based client scheduling system having at least one tangible processor and at least one tangible computer readable storage medium;
b) determining advances or delays in later client appointments based on advances or delays in previous client appointments; and
c) notifying patients via personal electronic notification of an anticipated actual time of appointment based on the advances or delays, thereby allowing clients to avoid spending prolonged, substantial, unwanted or unexpected periods of time waiting.

12. The method of claim 11, wherein said at least one client information entered into at least one computer-based client scheduling system is entered from at least one telecommunication device such as a personal computer.

13. The method of claim 11, wherein said at least one client information includes client name.

14. The method of claim 11, wherein said at least one client information includes scheduled time of appointment.

15. The method of claim 11, wherein said at least one client information includes at least one of the client' mobile telephone number, email address, other personal electronic notification format, or a combination thereof.

16. The method of claim 11, wherein said at least one personal electronic notification is email.

17. The method of claim 11, wherein said at least one personal electronic notification is telephony text messaging.

18. The method of claim 11, wherein said at least one personal electronic notification is an automated voice message.

19. The method of claim 11, wherein said appointment is in a medical, para-medical or non-medical related setting, or a combination thereof.

20. A method for notifying patients of time information pertaining to scheduled medical appointments, comprising:
a) entering at least one patient information into at least one tangible computer storage medium accessible to at least one patient scheduling system computer;
b) monitoring scheduled appointments using the patient scheduling system computer;
c) determining a time change in a first scheduled appointment at least in part based on at least one advance or delay in a second scheduled appointment, the second scheduled appointment being previous to the first scheduled appointment;
d) based at least in part on the time change, notifying a patient associated with the first scheduled appointment via personal electronic notification of an anticipated actual time of a modified appointment to replace the first scheduled appointment; and
e) receiving from the patient an electronic signal indicating that the patient accepts, rejects, cancels, desires to reschedule the modified appointment, or a combination thereof.

21. The method of claim 20, wherein said at least one patient information entered into said at least one tangible computer storage medium is entered from at least one telecommunication device such as a personal computer.

22. The method of claim 20, wherein said at least one patient information includes patient name.

23. The method of claim 20, wherein said at least one patient information includes scheduled time of appointment.

24. The method of claim 20, wherein said at least one patient information includes at least one of the patient's mobile telephone number or email address, other personal electronic notification format, or a combination thereof.

25. The method of claim 20, wherein said at least one personal electronic notification is email.

26. The method of claim 20, wherein said personal electronic notification is telephony text messaging.

27. The method of claim 20, wherein said at least one personal electronic notification is an automated voice message.

28. The method of claim 20, wherein in response to the electronic signal received from the patient, the scheduling system computer alters the modified appointment.

29. A system, comprising:
a) means for monitoring scheduled appointments;
b) means for determining a time change in a first scheduled appointment at least in part based on at least one advance or delay in a second scheduled appointment, the second scheduled appointment being previous to the first scheduled appointment;
c) means for notifying a patient associated with the first scheduled appointment via personal electronic notification of an anticipated actual time of a modified appointment to replace the first scheduled appointment based at least in part on the time change; and
e) means for receiving from the patient an electronic message indicating that the patient accepts, rejects, cancels, or desires to reschedule the modified appointment.

30. The system of claim 29, wherein scheduled appointments are monitored using a patient scheduling system.

31. The system of claim 29, wherein the personal electronic notification is email.

32. The system of claim 29, wherein the personal electronic notification is telephony text messaging.

33. The system of claim 29, wherein the personal electronic notification is an automated voice message.
